(19) United States
(12) Patent Application Publication
(10) Pub. No.: US 2011/0072467 A1
(43) Pub. Date: Mar. 24, 2011

(54) METHOD AND APPARATUS FOR PROVIDING INFORMATION BETWEEN CLIENTS IN MULTIMEDIA BROADCAST SYSTEM

(75) Inventors: Kang-Chun LEE, Suwon-si (KR); Chang-Dae BANG, Hwaseong-si (KR)

(73) Assignee: Samsung Electronics Co., Ltd., Suwon-si (KR)

(21) Appl. No.: 12/886,944

(22) Filed: Sep. 21, 2010

(30) Foreign Application Priority Data
Sep. 23, 2009 (KR) 10-2009-0090287

(51) Int. Cl. G06F 15/16; H04N 5/445

(52) U.S. Cl. 725/56; 709/231

(57) ABSTRACT

A method for providing information between clients in a multimedia broadcast system. The method includes receiving information about a specific client connected to a home server; receiving and analyzing a request from the client; if the received request is a request for streaming information, which includes content currently being streamed in the home server and information about a client receiving the content, providing the streaming information to a client that transmitted the request; upon receiving from the client a streaming providing request for providing its streaming content to another client, extracting information about target content and a target client from the received streaming providing request; and delivering the information about the target content to the target client.

### PRIORITY

This application claims priority under 35 U.S.C. §119(a) to a Korean Patent Application filed in the Korean Intellectual Property Office on Sep. 23, 2009 and assigned Serial No. 10-2009-0090287, the entire disclosure of which is hereby incorporated by reference.

### BACKGROUND OF THE INVENTION

1. Field of the Invention

The present invention relates generally to a multimedia broadcast system, and more particularly, to a method and apparatus for providing content or a message that a client is streaming, to other clients in a multimedia broadcast system.

2. Description of the Related Art

A multimedia broadcast system providing multimedia data to a plurality of users and devices generally includes a home server for streaming multimedia data and a plurality of clients that receive multimedia data from the home server. Moreover, a multimedia broadcast system may be built based on the Digital Living Network Alliance (DLNA) standard for digital home networking. In this case, a Digital Media Control (DMC) point designates a location of a Digital Media Server (DMS) and an address of content stored in the DMS, and provides the designated information to a Digital Media Renderer (DMR) for playing content. Then the DMR may send a request for the designated content to the DMS, and receive a streaming service for the requested content.

In a general multimedia broadcast system, for multimedia search and playback, a home server searches for necessary multimedia information using metadata information such as a file name of multimedia data retained in a multimedia content server. After the search, the home server provides a list of searched contents to a client based on a predefined transport protocol, and the client receives the list of searched contents, analyzes the list information, and displays the analyzed information on a user interface (or a display). Next, if content to be played is selected by a user in the client device, information about the selected content is delivered to the home server in accordance with a predefined protocol, and the home server streams the requested content data to the client device according to the predefined protocol.

Since the multimedia content search and playback scheme of the conventional home server is based on multimedia data stored in the server, this scheme offers a search method for the content stored in the server, but does not provide search and playback functions for the content and broadcast currently being streamed by the server.

In addition, since the conventional home server system aims at distribution of its own content, the system does not manage information about the client device that has requested the content. Therefore, it is not possible to determine which client device is playing which content, and a specific client device may not share information with other client devices.

For this reason, if a user intends to provide multimedia content being played in his or her own client device to other client devices, the user must inconveniently provide information about the content being played in his or her own client device to users of other client devices so that the users of other client devices may directly search and find the content using the information about the content.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for providing streaming information of other users to a specific client so that the client may easily obtain information about the other clients and other users and information about the broadcast or multimedia content that the other clients are playing, in a multimedia broadcast system for a plurality of users.

Another aspect of the present invention is to provide a method and apparatus in which a client can easily provide the content that the client is streaming, to other clients.

In accordance with one aspect of the present invention, there is provided a method for providing information between clients in a multimedia broadcast system, the method including receiving information about a specific client connected to a home server; receiving and analyzing a request from the client; if the received request is a request for streaming information, which includes content currently being streamed in the home server and information about a client receiving the content, providing the streaming information to a client that transmitted the request; upon receiving from the client a streaming providing request for providing its streaming content to another client, extracting information about target content and a target client from the received streaming providing request; and delivering the information about the target content to the target client.

In accordance with another aspect of the present invention, there is provided an apparatus for providing information between clients in a multimedia broadcast system, the apparatus including a tuner for receiving a plurality of broadcast signals; a broadcast receiver for selecting a channel of the broadcast signals, and creating a channel list and broadcast information; a storage device for storing multimedia content data; a content searcher for acquiring a list of the storage device, and searching content in the storage device; a request transceiver for receiving a request from a client; a connection manager for, upon receipt of a content request from the request transceiver, controlling to deliver requested content to a multimedia transmitter so that the requested content may be streamed in the client that requested the content, storing the streaming information in a database, providing the stored streaming information to the client that transmitted the request if a streaming information request is received from the request transceiver, and if a streaming providing request for providing content being streamed by the client to another client is received from the request transceiver, controlling to extract target content and information about a target client from the received streaming providing request, and to deliver information of the target content to the target client; and the multimedia transmitter for delivering the multimedia content received from the connection manager to a client that requested streaming.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram of an apparatus for providing information between clients in a multimedia broadcast system according to an embodiment of the present invention;

FIG. 2 is a flowchart showing an operation for providing streaming information in a multimedia broadcast system according to an embodiment of the present invention;

FIG. 3 is a flowchart showing an operation of receiving information about client devices by a home server during an operation for providing streaming information in a multimedia broadcast system according to an embodiment of the present invention;

FIG. 4 is a flowchart showing an operation of a request transceiver during an operation for providing streaming information in a multimedia broadcast system according to an embodiment of the present invention;

FIG. 5 is a flowchart showing an operation of a connection manager during an operation for providing streaming information in a multimedia broadcast system according to an embodiment of the present invention;

FIG. 6 is a diagram showing a streaming information table stored in a home server during an operation for providing streaming information in a multimedia broadcast system according to an embodiment of the present invention;

FIG. 7 is a flowchart showing an operation of a remote UI provider during an operation for providing streaming information in a multimedia broadcast system according to an embodiment of the present invention;

FIG. 8 is a diagram showing an example of streaming up/down during an operation for providing streaming information in a multimedia broadcast system according to an embodiment of the present invention;

FIG. 9 is a diagram showing contents being streamed to clients in a multimedia broadcast system according to an embodiment of the present invention;

FIG. 10 is a diagram showing an example of providing streaming information in a multimedia broadcast system according to an embodiment of the present invention;

FIG. 11 is a flowchart showing an operation for providing information between clients in a multimedia broadcast system according to an embodiment of the present invention;

FIG. 12 is a diagram showing an example of images displayed on a display of a first client during information exchange between clients in a multimedia broadcast system according to an embodiment of the present invention;

FIG. 13 is a diagram showing an example of images displayed on a display of a third client receiving information from a first client during information exchange between clients in a multimedia broadcast system according to an embodiment of the present invention; and

FIG. 14 is a flowchart showing an operation of extracting information about target content during information exchange between clients in a multimedia broadcast system according to an embodiment of the present invention.

Throughout the drawings, the same drawing reference numerals will be understood to refer to the same elements, features and structures.

### DETAILED DESCRIPTION OF EMBODIMENTS OF THE PRESENT INVENTION

Embodiments of the present invention will now be described in detail with reference to the accompanying drawings. In the following description, specific details such as a detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The present invention provides a method and apparatus for providing information about other clients and streaming information of other clients to a specific client in a multimedia broadcast system for a plurality of users, and also provides a method and apparatus in which a client provides the content that the client is streaming, to other clients, or provides information such as messages and image files to other clients. To this end, the present invention provides a method in which a home server provides streaming information indicating the current streaming status to clients, and upon receiving a streaming providing request to other clients from a client, the home server extracts, from the streaming providing request, target content to be streamed and information about a target client that will provide streaming, provides address or channel information of the extracted target content to the extracted target client, and streams the target content to the target client upon receiving a play request for the target content from the target client. A detailed description thereof will be given below with reference to the accompanying drawings.

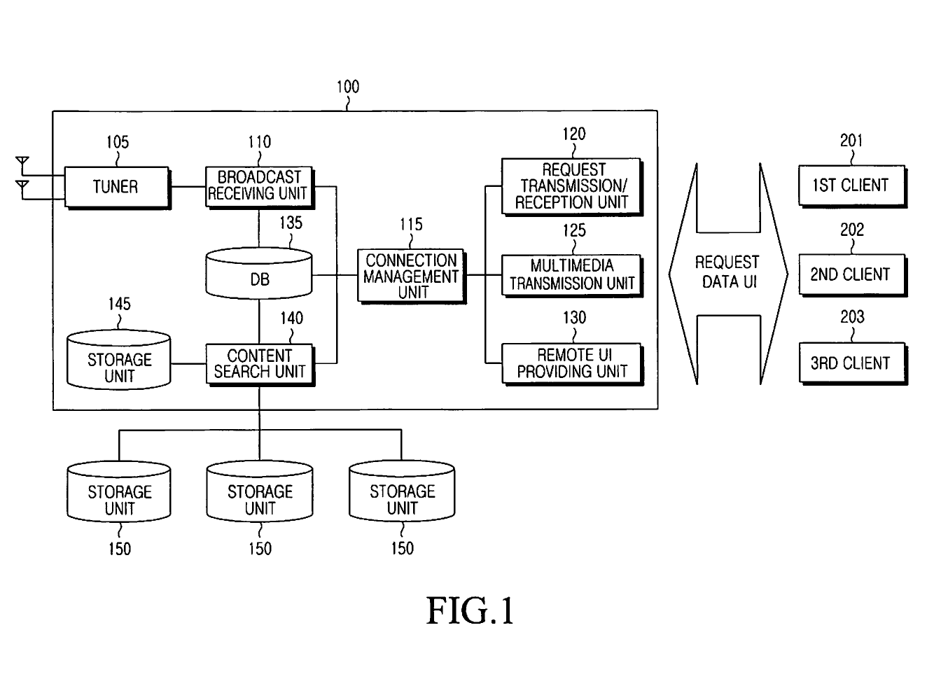

FIG. 1 shows an apparatus for providing streaming information in a multimedia broadcast system according to an embodiment of the present invention.

Referring to FIG. 1, a home server 100 for providing streaming information in a multimedia broadcast system, includes a tuner 105, a broadcast receiver 110, a connection manager 115, a request transceiver 120, a multimedia transmitter 125, a remote User Interface (UI) provider 130, a database (DB) 135, a content searcher 140, an internal storage unit 145, and external storage devices 150.

The tuner 105 receives broadcast signals, and may include a plurality of tuners.

The broadcast receiver 110 selects a channel using a given frequency. In the case of an Advanced Television Systems Committee (ATSC) system, the broadcast receiver 110 selects a channel based on a Physical Transmission Channel (PTC). The broadcast receiver 110 creates a channel list and broadcast information by analyzing an Electronic Program Guide (EPG) and section table data in the received broadcast signals, and performs an operation for registration in the DB 135 and a broadcast playback.

The content searcher 140 obtains a list of the storage devices 145 and 150 connected to the home server 100, and searches content in the storage devices. The content searcher 140 secures a list of the storage devices 145 and 150 it can access using a scheme such as Universal Plug and Play (UPnP) and Digital Living Network Alliance (DLNA), and registers the acquired list in the DB 135.

The request transceiver 120 receives a request from each of a plurality of renderer devices, or client devices, which are connected to the home server 100, and/or transmits a request to each of the client devices. In an embodiment of the present invention, the request transceiver 120 performs network connection upon receiving a connection request from a client device, delivers information about target content to be streamed and a received request to the connection manager 115 upon receiving a streaming request, and delivers information about a received streaming information request to the remote UI provider 130 upon receiving a request for streaming information indicating the current streaming status.

In addition, upon a streaming providing request to other clients, the request transceiver 120 may deliver information about target content to a target client included in the request. Subsequently, upon receiving a play request for the target content, transmitted from the target client, the request transceiver 120 delivers information about the target content and the received request to the connection manager 115. The reason why the request transceiver 120 makes the re-request is that since the device that sent the streaming providing request to the other clients is not a server, but a client, the device cannot directly receive content data of the home server. Therefore, the request transceiver 120 delivers information about the target content to be played to a target client so that the target client may play the target content. If the target client does not want to stream the target content, the target client may ignore the request.

If information about target content to be streamed is received from the request transceiver 120, the connection manager 115 loads the content information and delivers the loaded information to the multimedia transmitter 125. Moreover, the connection manager 115 stores, in the DB 135, information about a client that sent the request, and information about the content to be transmitted, which were received from the request transceiver 120, and streaming information such as streaming status information. If the requested content is live broadcast content, the connection manager 115 delivers a request to the broadcast receiver 110 to acquire a requested broadcast content stream, and delivers the acquired stream to the multimedia transmitter 125. If the requested content is multimedia content stored in the internal storage device 145 and the external storage devices 150, the connection manager 115 loads the multimedia content that is stored in the home server 100 or stored through the external network, and delivers the loaded content to the multimedia transmitter 125. The connection manager 115 manages the current streaming status using a streaming index list. During this management, if new streaming starts, related streaming information is added in the streaming index list, and if streaming is terminated, associated streaming information is deleted from the streaming index list. Details of the streaming information may be separately stored and managed in the DB 135.

Upon receiving a live content request from the request transceiver 120, the connection manager 115 delivers channel index information included in the request information to the broadcast receiver 110, and controls the broadcast receiver 110 to select a channel using the channel index and to provide live content to the connection manager 115, and the connection manager 115 delivers the received live content and client information included in the request information to the multimedia transmitter 125, and controls the multimedia transmitter 125 to stream the live content to the client.

The multimedia transmitter 125 streams and/or uploads the multimedia content provided from the connection manager 115, to the client that requested streaming. A protocol used for transmission of the multimedia content may include transport protocols such as a Hyper Text Transport Protocol (HTTP), a Realtime Transport Protocol (RTP) and a User Datagram Protocol (UDP).

Upon receiving a request for streaming information indicating the current streaming status from a client device, the remote UI provider 130 creates a Hyper Text Markup Language (HTML) user interface using streaming information including client information, content information and play status information, which are managed in the connection manager 115, and provides the created user interface to the client. In this case, the user interface provided to the client may include information about each client, information about the content being streamed and play status information of the content being streamed to each client. Information represented on the user interface may be displayed in thumbnail images or icons, and simplified symbols. In addition, the user interface may include a streaming play request with which a user may request each client to select one of contents being streamed and to play the selected content in his or her own client, and may also include an interface with which the user can select a streaming content up/down request and a streaming device up/down request enabling each client to sequentially select the content being streamed in a similar manner to conventional channel selection.

The internal storage device 145 and the external storage devices 150 store multimedia content. The internal storage device 145 is located inside the home server 100, while the external storage devices 150 are located outside the home server 100 and connected to the home server 100 directly or through a network.

The home server 100 may exchange request signals, content data, user interfaces, etc. with a plurality of clients 201, 202 and 203 through the request transceiver 120, the multimedia transmitter 125 and the remote UI provider 130.

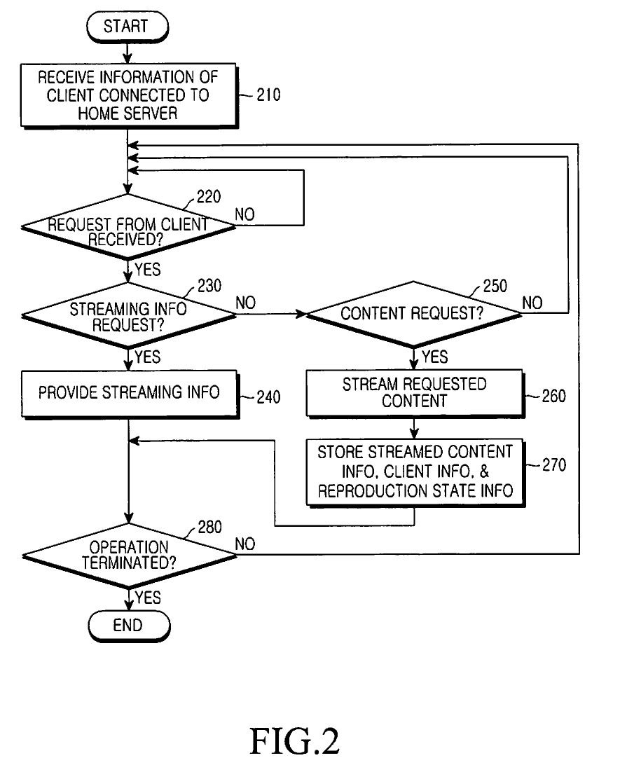

FIG. 2 shows an operation for providing streaming information in a multimedia broadcast system according to an embodiment of the present invention.

An operation of the home server 100 for providing streaming information in a multimedia broadcast system will be described with reference to FIG. 2. In step 210, the home server 100 receives information about clients 201, 202 and 203 connected to the home server 100. This client information may be received every time a new client is connected.

In step 220, the home server 100 determines if a request is received from at least one of the clients 201, 202 and 203. If no request is received, the home server 100 continues to wait for a request. Upon receipt of a request, the home server 100 determines in step 230 whether the received request is a streaming information request. If so, the home server 100 provides streaming information to the client that transmitted the streaming information request, in step 240. The streaming information includes information about the content currently being streamed, information about the client receiving the streaming, and information about the streaming status.

If the received request is not the streaming information request in step 230, the home server 100 determines in step 250 whether the received request is a content request. If not so, the home server 100 returns to step 220. However, if the received request is a content request in step 250, the home server 100 streams the requested content to the client that transmitted the content request, in step 260. In this case, if the requested content is broadcast content, the home server 100 delivers the request information to the broadcast receiver 110, to select a channel and stream the requested broadcast content, and if the requested content is content stored in the storage devices 145 and 150, the home server 100 delivers the request information to the content searcher 140, to search for the requested content and stream the searched content. In an embodiment of the present invention, a streaming content request for the content currently being streamed may be received. In this case, the home server 100 immediately delivers information about the client that sent the request, to the multimedia transmitter 125, to add the content subjected to streaming by the multimedia transmitter 125 and to instruct the multimedia transmitter 125 to immediately perform streaming.

In step 270, the home server 100 stores information about the new content being streamed, and streaming information including client information and play status information, thereby updating the streaming information stored in the DB 135 of the home server 100.

In step 280, the home server 100 determines if the operation has been terminated. Based on the determination, the home server 100 ends the operation, or returns to step 220 and repeats its succeeding steps.

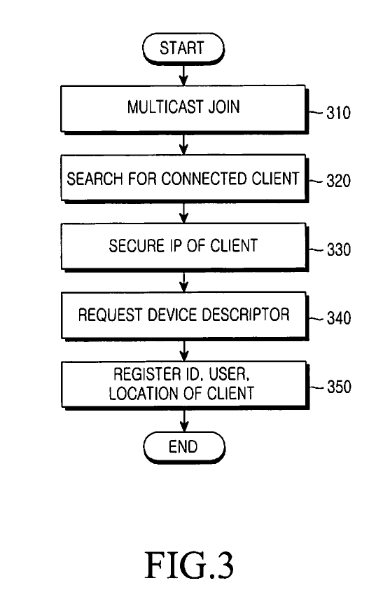

FIG. 3 shows an operation of receiving information about client devices by a home server during an operation for providing streaming information in a multimedia broadcast system according to an embodiment of the present invention. The operation process of FIG. 3 corresponds to the operation of step 210 in FIG. 2.

Referring to FIG. 3, if a specific client joins a multicast group (or performs a multicast join) in the home server 100 in step 310, the home server 100 searches for the newly joined client in step 320. The home server 100 secures an IP of the client in step 330, and requests a descriptor of the client device in step 340. The home server 100 registers client information such as a client ID, a user, and a client location, in step 350.

In an embodiment of the present invention, a home server and clients may constitute a network using DLNA or UPnP, and the clients use DLNA or UPnP even when connecting with the home server. In the case of UPnP, all devices to be controlled have their description XML files describing themselves. These files are delivered to a UPnP access point through a UPnP discovery operation in the way defined in the UPnP Specification.

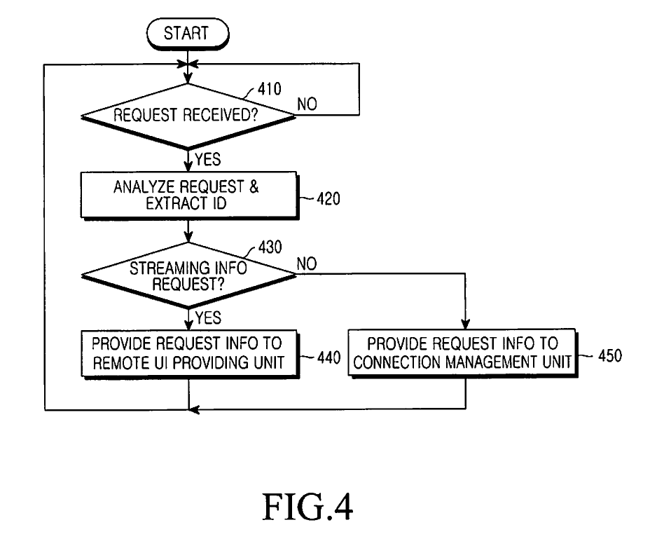

FIG. 4 shows an operation of the request transceiver 120 during an operation for providing streaming information in a multimedia broadcast system according to an embodiment of the present invention.

Referring to FIG. 4, the request transceiver 120 determines in step 410 whether a request is received from at least one of the clients 201, 202 and 203. If no request is received, the request transceiver 120 continues to wait for a request. Upon receipt of a request, the request transceiver 120 analyzes the received request and extracts a device ID of the client in step 420. The request transceiver 120 determines in step 430 whether the received request is a streaming information request. If so, the request transceiver 120 delivers information about the received request to the remote UI provider 130 in step 440, and then returns to step 410 to wait for a request to be received. However, if the received request is not the streaming information request in step 430, the request transceiver 120 provides information about the received request to the connection manager 115 in step 450, and then returns to step 410.

In the case where the home server 100 provides an HTML UI to the clients 201, 202 and 203 together with a remote UI, since an HTML script prepared in the home server 100 is transmitted to the clients 201, 202 and 203, all request command protocols may be defined in the home server 100. If the remote UI is not utilized, request commands between the clients 201, 202 and 203 and the home server 100 may be defined in the clients 201, 202 and 203. When providing a request command, each of the clients 201, 202 and 203 provides a command type, a parameter associated with the command, and its own unique ID.

Commands, or requests, used in the clients 201, 202 and 203 may include a live channel setting request for setting a live broadcast channel, a live channel recording request for recording a live broadcast channel, a live channel play request (live content request) for playing a live broadcast, a stored content play request for playing content stored in the storage devices, a stored content download request for downloading content stored in the storage devices, a streaming information request for getting information about the content currently being streamed to other clients, a streaming content request for playing the content currently being streamed to other clients, a streaming content up/down request for selecting and playing the content currently being streamed by other clients, and a streaming device up/down request for selecting and playing the content currently being streamed by other clients, among other commands or requests.

The live channel setting request may include information such as a channel index, and the stored content play request may include information such as a content Uniform Resource Identifier (URI).

Like a broadcast channel up/down request, the streaming content up/down request is a command to perform streaming on the next streaming content or previous streaming content with respect to the content being streamed, which includes live broadcasts. Accordingly, the content may be sorted to set the change order during an up/down operation.

The streaming device up/down request is a request for receiving streaming of the content being played in the next device or previous device in a list of devices receiving streaming. Accordingly, the types of the streaming devices may be sorted to set the change order during an up/down operation. For example, if there are an audio renderer such as an MP3 player, and a video renderer such as a Set-Top Box (STB), a TV and a Portable Multimedia Player (PMP), the streaming device up/down request may be set to first navigate the contents provided to the video renderer device and then go to the content provided to the audio renderer and perform streaming on the content.

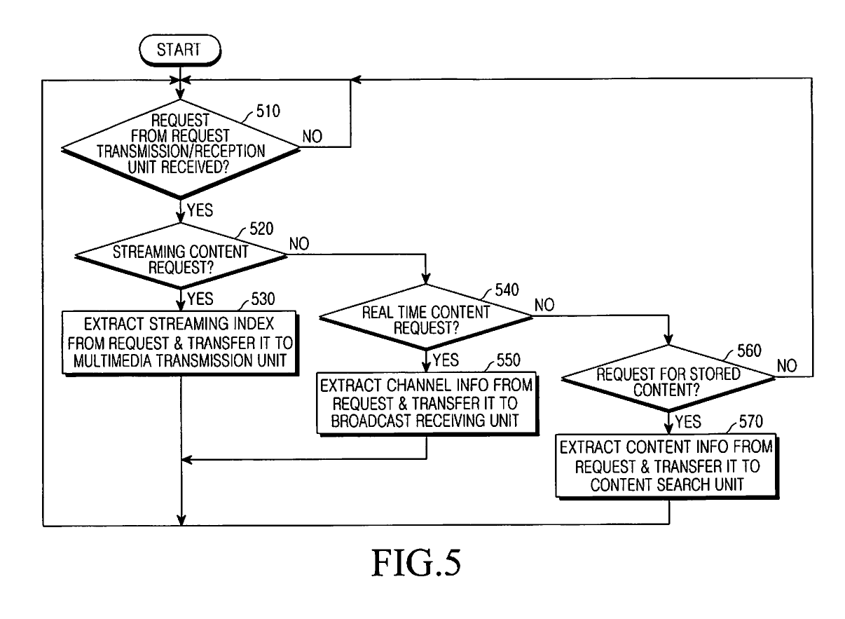

FIG. 5 shows an operation of the connection manager 115 during an operation for providing streaming information in a multimedia broadcast system according to an embodiment of the present invention.

Referring to FIG. 5, the connection manager 115 determines in step 510 whether a request is received from the request transceiver 120. If no request is received, the connection manager 115 continues to wait for a request. Upon receipt of a request, the connection manager 115 determines in step 520 whether the received request is a streaming content request. If so, the connection manager 115 extracts a streaming index from the request information and delivers the extracted index to the multimedia transmitter 125 in step 530, and then returns to step 510.

As such, if a client has requested the content currently being streamed, it can be considered that the home server 100 is already performing streaming on a broadcast channel or content data acquired from the storage devices 145 and 150. In this case, the connection manager 115 immediately delivers device information of the client to the multimedia transmitter 125 to add the content currently being streamed as the content subjected to streaming so that the content may be immediately subject to streaming. That is, the connection manager 115 is controlled to deliver client and content information requested for streaming in the request information to the multimedia transmitter 125 and to stream the requested content information to the requested client. Accordingly, the connection manager 115 may immediately perform streaming without a separate content loading or selection process.

If the received request is not a streaming content request in step 520, the connection manager 115 determines in step 540 whether the received request is a live content request. If so, the connection manager 115 extracts channel information from the received request information and delivers the extracted information to the broadcast receiver 110 in step 550, and then returns to step 510.

For reference, upon receipt of the live content request, the connection manager 115 delivers channel index information included in the request to the broadcast receiver 110, and the broadcast receiver 110 acquires the requested live broadcast data by selecting a channel using the given channel index and provides the acquired data to the connection manager 115. The connection manager 115 delivers the received live broadcast data and client information to the multimedia transmitter 125 so that the live broadcast may be streamed to the client.

If the received request is not the live content request in step 540, the connection manager 115 determines in step 560 whether the received request is a stored content request. If not, the connection manager 115 returns to step 510. Otherwise, if the received request is the stored content request, the connection manager 115 extracts content information from the received stored content request and delivers the extracted information to the content searcher 140 in step 570.

For reference, upon receiving the stored content request, the connection manager 115 delivers URI information included in the request to the content searcher 140, and the content searcher 140 acquires content data having the requested URI and provides the acquired data to the connection manager 115. The connection manager 115 delivers the received content data to the multimedia transmitter 125 together with the client information so that the stored multimedia content may be streamed to the client.

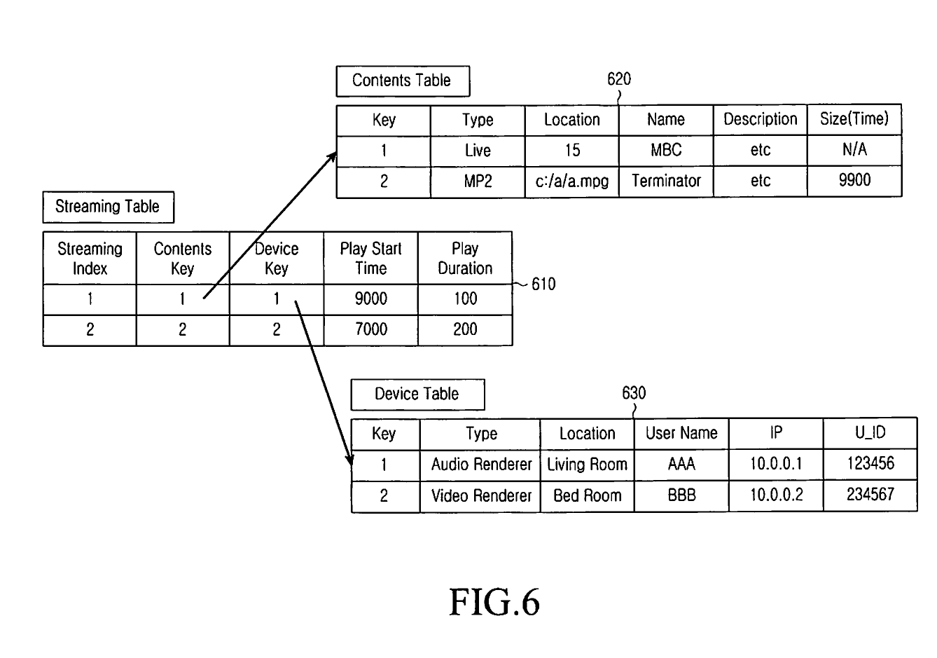

By performing the above operations upon the three different content requests, the connection manager 115 updates in the DB 135 the streaming information including client information and content information, being streamed, and information about the streaming status at every given time. This streaming information will be described with reference to the streaming information-related table in FIG. 6.

FIG. 6 shows a streaming information table stored in a home server during an operation for providing streaming information in a multimedia broadcast system according to an embodiment of the present invention.

As shown in FIG. 6, Streaming Table 610 includes information about a streaming index, a contents key, a device key, a play start time, and a play duration, and each content includes its own content information table, Content Table 620. The Content Table 620 includes information about a key, a type, a location, a name, a description, and a size/time. Each client device also includes its own client device information table, Device Table 630, and Device Table 630 includes information about a key, a type, a location, a user name, an IP address and a U_ID.

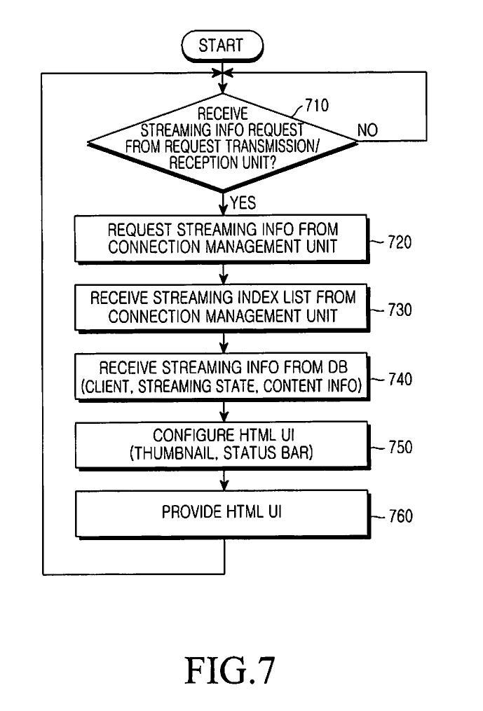

FIG. 7 shows an operation of the remote UI provider 130 during an operation for providing streaming information in a multimedia broadcast system according to an embodiment of the present invention. As shown in FIG. 7, in providing streaming information, the remote UI provider 130 may display the streaming information on all clients with a browser using an HTML remote UI.

Referring to FIG. 7, the remote UI provider 130 determines in step 710 whether a streaming information request is received from the request transceiver 120. If not, the remote UI provider 130 continues to wait for a streaming information request. Upon receipt of a streaming information request, the remote UI provider 130 sends a request for streaming information to the connection manager 115 in step 720. Subsequently, in step 730, the remote UI provider 130 receives a streaming index list from the connection manager 115. In step 740, the remote UI provider 130 receives streaming information such as client information, status and content information in the streaming index list from the DB 135. In step 750, the remote UI provider 130 configures an HTML UI, on which broadcast images may be displayed in the form of thumbnails and streaming status information may be represented by a status bar. In step 760, the remote UI provider 130 provides the created HTML UI to the client that requested the streaming information.

In the case of live broadcast content, the streaming information request may be used to provide program information such as a thumbnail image for a screen, unique number and name of a service or channel, an air time, a broadcast name, and a current play time. In the case of stored content information, the streaming information request may be used to provide content metadata such as a thumbnail image, the total playing time, a current play time, a file name, a file type, a genre, and an author. In addition, the streaming information request may provide device type information, device name information, device location information and device user information, as the client device information.

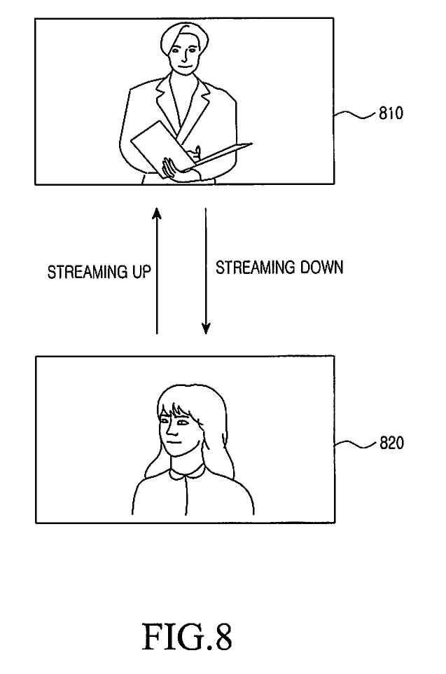

FIG. 8 shows an example of streaming up/down during an operation for providing streaming information in a multimedia broadcast system according to an embodiment of the present invention.

Referring to FIG. 8, if a movie 810 is being played in a first client and a drama 820 is being played in a second client, then a third client may identify the content presently being played in the first client and the second client by sending a streaming information request. In this case, a user of the third client may easily select and play his or her preferred content using a streaming content up/down request or a streaming device up/down request.

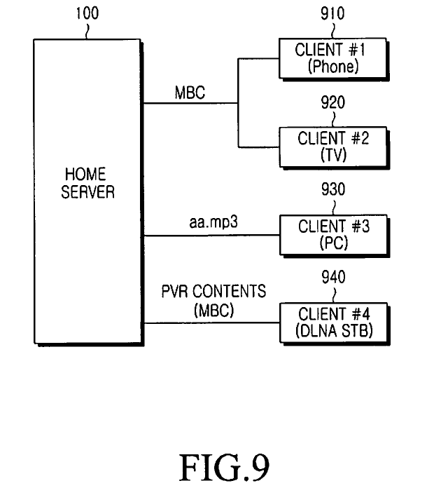

FIG. 9 shows content being streamed to clients in a multimedia broadcast system according to an embodiment of the present invention.

Referring to FIG. 9, a first client 910 and a second client 920 are a phone and a Television (TV), respectively, and are playing a broadcast of the Munhwa Broadcasting Corporation (MBC) in common, and a third client 930 is a Personal Computer (PC), and is playing stored content ‘aa.mp3’. In addition, a fourth client 940 is a DLNA STB, and is playing Personal Video Recorder (PVR) content of MBC.

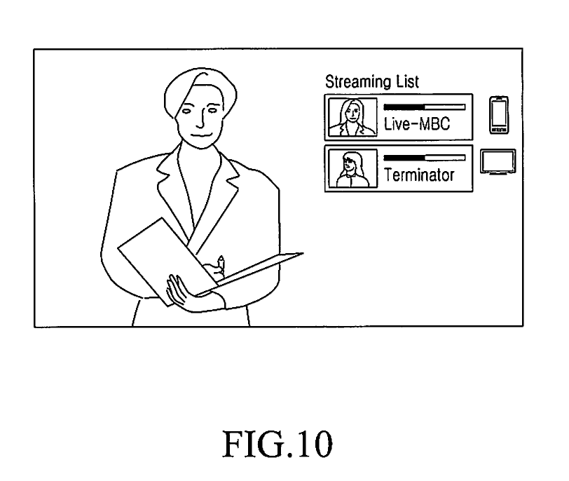

FIG. 10 shows an example of providing streaming information in a multimedia broadcast system according to an embodiment of the present invention.

As shown in FIG. 10, according to the streaming information providing method in a multimedia broadcast system of the present invention, a client may output thumbnail images being played by other clients, on the right top of its screen, and information such as names, elapsed playing times, and client types of the content being streamed may be displayed such that they can be easily understood at a glance.

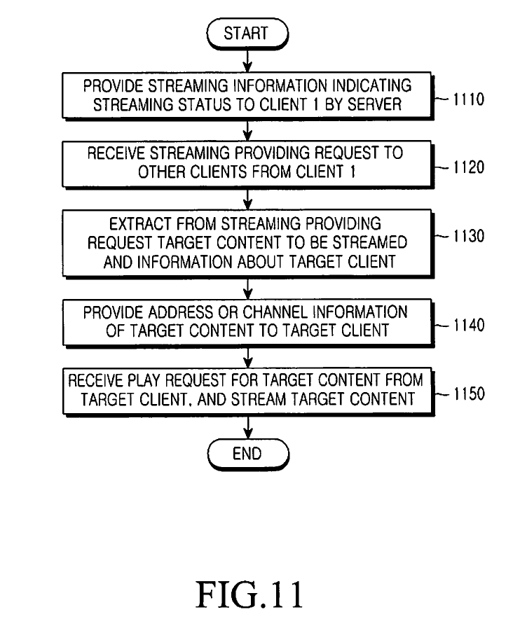

FIG. 11 shows an operation for providing information between clients in a multimedia broadcast system according to an embodiment of the present invention. In order for a client to provide its content to other clients, the client should first have information about the other clients. Therefore, for exchange of information such as content or messages between clients, an operation of receiving information about other clients and streaming information including the status of the content currently being streamed should precede others.

Referring to FIG. 11, upon a request (not shown) of a first client, the home server 100 provides streaming information indicating its current streaming status to the first client in step 1110. If a streaming providing request to other clients is received from the first client in step 1120, the home server 100 extracts, from the streaming providing request, target content to be streamed and information about a target client that will stream the content, in step 1130. In step 1140, the home server 100 provides the target client with address or channel information of the target content. In this case, the request transceiver 120 transmits a URI of the target content to the target client, and in a DLNA multimedia broadcast system, a protocol is defined, based on which a Digital Media Controller (DMC) provides content to be played, to a DLNA Digital Media Renderer (DMR). Accordingly, the request transceiver 120 serving as a DMC may transmit information about the content to be played, to the target client serving as a DMR.

In step 1150, upon receiving a play request for the target content from the target client, the home server 100 streams the target content to the target client.

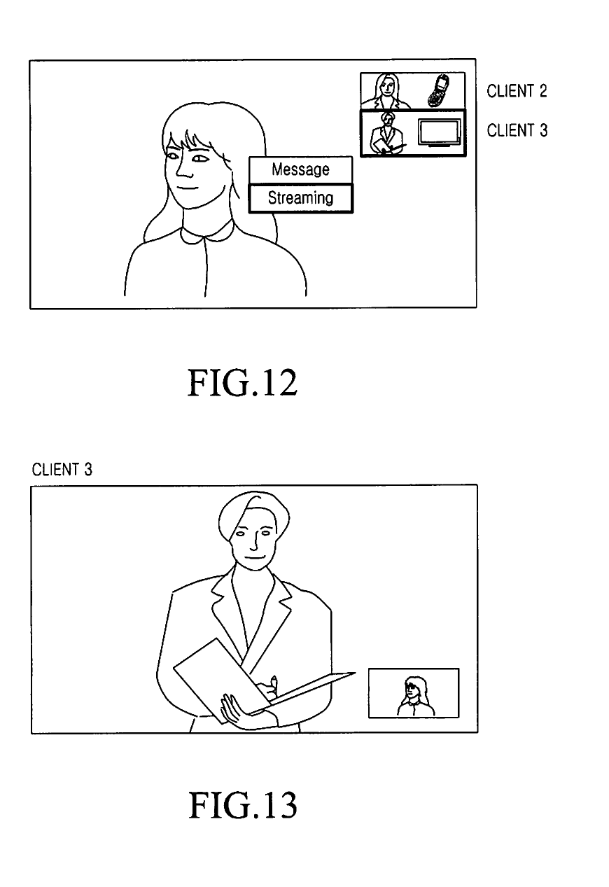

FIG. 12 shows an example of images displayed on a display of a first client during information exchange between clients in a multimedia broadcast system according to an embodiment of the present invention. FIG. 13 shows an example of images displayed on a display of a third client receiving information from a first client during information exchange between clients in a multimedia broadcast system according to an embodiment of the present invention.

If a first client receives streaming information indicating the streaming status of the home server, a Picture-In-Picture (PIP) screen like that shown in FIG. 10 may be displayed on the first client. In this state, if a user selects one of the contents being streamed by respective clients, displayed on the right top of the screen, using a user interface, then a menu pops up as shown in FIG. 12, through which the user can select a message transmission or streaming transmission for providing the content being streamed by the first client itself. Through this user interface, the user may transmit messages to other clients, or may provide its own content being streamed, to other clients. In addition to the message transmission and the streaming transmission, the client may transmit images obtained by capturing its screen.

In the case where the first client receives a user interface from the home server, the first client does not need a separate system and only needs to select a desired function through an input device. On the other hand, in the case where a client uses its own UI rather than a UI of the home server, the client transmits target client information and information about the content currently being streamed, to the home server in accordance with a predefined protocol.

A method for delivering a request from a client to the home server may be realized in various different ways. Table 1 below shows an example in which a client sends a request command and its associated information to the home server using an HTTP GET method, and Table 2 below shows an example in which a client sends a request command and its associated information to the home server using an HTTP POST method.

TABLE 1

```
      GET/Command?name=Transfer_streaming_data&Contents=
livestream_14&TargetClientID=3 HTTP/1.1
      Connection : Keep_Alive
      Use_Agent : Mozilla/4.03
      Accept : */*
```

TABLE 2

```
POST /Command HTTP/1.1
  Connection : Keep_Alive
  Use_Agent : Mozilla/4.03
  Accept : */*
  Content-type : application / x-www-form-urlencoded
  Content-length : 67
  name=Transfer_streaming_data&Contents=
  livestream_14&TargetClientID=3
```

Tables 1 and 2 above show a command to request a device with a client ID=3 to stream broadcast content of Livestream 14.

These requests transmitted from a client to the home server may include a message transmission request to other clients, a streaming transmission (providing) request, and a captured image transmission request.

In the case of the message transmission request, its command type is message transmission and its content parameter becomes message streaming. In the case of the streaming transmission request, its command type is streaming transmission and its content parameter becomes a URI of content. In the case of the captured image transmission request, its command type is message transmission and its content parameter becomes image data.

FIG. 12 shows a situation in which a user of a first client intends to provide its content being streamed to a third client. If the first client selects a streaming providing request, this request is transmitted to the home server, and the home server informs the third client that the first client intends to provide its streaming to the third client. Then, as shown in FIG. 13, the screen of the first client is displayed small on the screen of the third client, informing that the first client intends to provide its streaming.

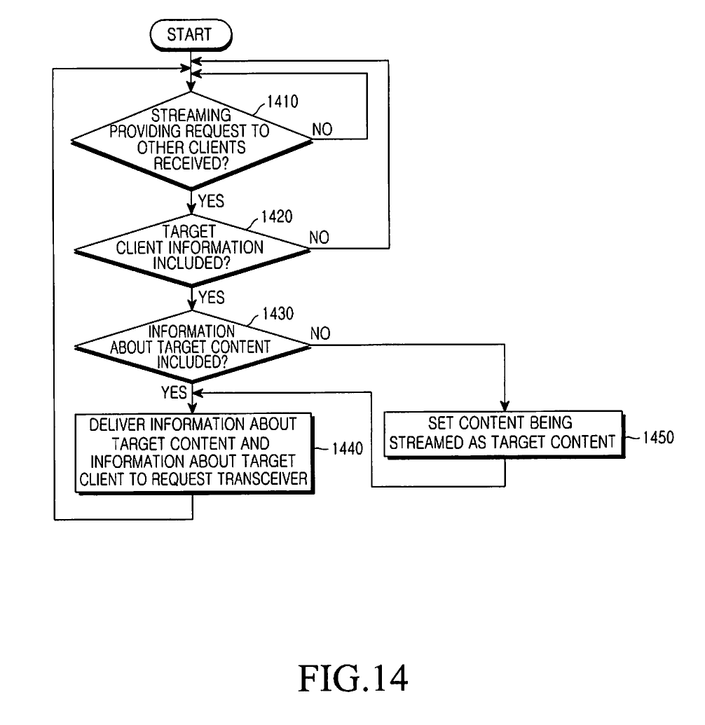

FIG. 14 shows an operation of extracting information about target content during information exchange between clients in a multimedia broadcast system according to an embodiment of the present invention. The operation of FIG. 14 corresponds to the operation of step 1130 in FIG. 11.

Referring to FIG. 14, the request transceiver 120 in the home server 100 determines in step 1410 whether a streaming providing request to other clients has been received. If not, the request transceiver 120 continues to wait for the request. Upon receiving the streaming providing request, the request transceiver 120 delivers the received request to the connection manager 115, and the connection manager 115 determines in step 1420 whether the received request includes information about a target client. If not, the connection manager 115 returns to step 1410, ignoring the received request. However, if the target client information is included, the connection manager 115 determines in step 1430 whether the received request includes information about content to be streamed. If so, the connection manager 115 delivers the information about target content to be streamed and the information about the target client to the request transceiver 120 in step 1440, and then returns to step 1410. However, if the received request does not include information about the target content to be streamed in step 1430, the connection manager 115 sets the content the client that transmitted the request is streaming, as target content, in step 1450, and then proceeds to step 1440.

As described above, as to the streaming providing request to other clients, target content may be content that the client that transmitted the request is streaming, or may be specific content designated by its user. In addition to the streaming, the client may transmit general messages or captured images to other clients.

As is apparent from the foregoing description, the present invention provides a client with information about other users or clients as well as streaming information of other clients in a multimedia broadcast system for a plurality of users, thus enabling the client to easily obtain information about broadcast or multimedia content that the other clients and users are playing.

In addition, based on information about other clients, a client may deliver messages to the other clients or may provide the other clients with content the client itself is playing.

In conclusion, a client may access a home server and easily obtain information about other clients, information about multimedia content the other clients are playing, and its play status and other information, and the client may deliver messages to the other clients or provide the other clients with its content being streamed, making it possible for its user to share the information with other users. In addition, a user may capture key scenes of the content he or she is watching, and share them with users of other clients. Moreover, when a home server uses a remote UI, a client may easily receive the above information from the home server by simply being equipped with a browser.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for providing information between clients in a multimedia broadcast system, comprising:
receiving information about a specific client connected to a home server;
receiving and analyzing a request from the client;
if the received request is a request for streaming information, which includes content currently being streamed in the home server and information about a client receiving the content, providing the streaming information to a client that transmitted the request;
upon receiving from the client a streaming providing request for providing its streaming content to another client, extracting information about target content and a target client from the received streaming providing request; and
delivering the information about the target content to the target client.

2. The method of claim 1, further comprising, upon receipt of a request for the target content from the target client, streaming the target content to the target client.

3. The method of claim 1, further comprising:
upon receiving from the client a message transmission request for transmitting a message to another client, extracting message information and information about a target client from the received message transmission request; and
delivering the message information to the target client.

4. The method of claim 1, further comprising:
upon receiving from the client an image transmission request for transmitting an image to another client, extracting, from the received image transmission request, information about an image to be transmitted and information about a target client; and
delivering the image information to the target client.

5. The method of claim 1, wherein extracting information about target content and a target client from the received streaming providing request comprises:
extracting information about a target client from the received streaming providing request; and
if information about content to be streamed is included in the received streaming providing request, setting the content to be streamed as target content, and if information about content to be streamed is not included, setting, as target content, content being streamed by a client that transmitted the request.

6. The method of claim 1, wherein the streaming information comprises information about content currently being streamed in the home server, information about a client receiving the content being streamed, and status information of the streaming.

7. The method of claim 6, wherein the information about content comprises information about a type, a storage location/channel, a name, a description, and a size/time of the content.

8. The method of claim 6, wherein the information about a client comprises information about a type, a location, a user name, and an Internet Protocol (IP) of the client.

9. The method of claim 6, wherein the streaming status information comprises a content start time and a total playing time.

10. The method of claim 1, further comprising, if the received request is a play request for content being streamed in the client, streaming the content being streamed in the client, to a client that transmitted the request.

11. The method of claim 1, further comprising, if a streaming operation is added in the home server upon the received request, storing streaming information for the added streaming operation.

12. The method of claim 1, wherein providing the streaming information to a client that transmitted the request, comprises creating a user interface displaying the streaming information of the home server, and providing the created user interface to a client that transmitted the request.

13. The method of claim 12, wherein the user interface comprises content currently being streamed, a client receiving the content currently being streamed, and information about a play status of the content currently being streamed.

14. The method of claim 13, further comprising, upon receiving through the user interface a play request for content currently being streamed to another client, streaming the requested content to the client that transmitted the request.

15. The method of claim 14, further comprising displaying, on the user interface, means for sequentially selecting and playing the content currently being streamed according to a type of a client playing the content.

16. The method of claim 12, wherein the user interface comprises means for selecting a request for providing content currently being streamed by the client to another client selected by a user.

17. The method of claim 12, wherein the user interface comprises means for selecting a request for providing a user input message to another client selected by a user.

18. The method of claim 13, wherein the user interface comprises means for selecting a request for providing an image file selected by a user to another client selected by the user.

19. An apparatus for providing information between clients in a multimedia broadcast system, comprising:
a tuner for receiving a plurality of broadcast signals;
a broadcast receiver for selecting a channel of the broadcast signals, and creating a channel list and broadcast information;
a storage device for storing multimedia content data;
a content searcher for acquiring a list of the storage device, and searching content in the storage device;
a request transceiver for receiving a request from a client;
a connection manager for, upon receipt of a content request from the request transceiver, delivering requested content to a multimedia transmitter so that the requested content may be streamed in the client that requested the content, storing streaming information in a database, providing the stored streaming information to the client that transmitted the request if a streaming information request is received from the request transceiver, and if a streaming providing request for providing content being streamed by the client to another client is received from the request transceiver, extracting target content and information about a target client from the received streaming providing request, and delivering information of the target content to the target client; and
the multimedia transmitter for delivering the multimedia content received from the connection manager to a client that requested streaming.

20. The apparatus of claim 19, wherein upon receiving a message transmission request for transmitting a message to another client from the connection manager through the request transceiver, the connection manager extracts message information and information about a target client from the received message transmission request and delivers the message information to the target client.

21. The apparatus of claim 19, wherein upon receiving an image transmission request for transmitting an image to another client from the client through the request transceiver, the connection manager extracts information about an image to be transmitted and information about a target client from the received image transmission request and delivers the image information to the target client.

22. The apparatus of claim 19, wherein extracting target content and information about a target client from the received streaming providing request in the connection manager, comprises extracting information about a target client from the received streaming providing request, setting content to be streamed as target content if information about the content to be streamed is included in the received streaming providing request, and setting, as target content, content being streamed by a client that transmitted the request if information about the content to be streamed is not included.

23. The apparatus of claim 19, wherein the multimedia transmitter uses at least one of a Hyper Text Transport Protocol (HTTP), a Realtime Transport Protocol (RTP) and a User Datagram Protocol (UDP) for transmission of multimedia content.

24. The apparatus of claim 19, wherein the streaming information comprises information about content being streamed, information about a client receiving the content, and streaming status information of the content.

25. The apparatus of claim 24, wherein the information about content comprises information about a type, a storage location/channel, a name, a description, and a size/time of the content.

26. The apparatus of claim 24, wherein the information about a client comprises information about a type, a location, a user name, and an Internet Protocol (IP) of the client.

27. The apparatus of claim 24, wherein the streaming status information comprises a content start time and a total playing time.

28. The apparatus of claim 19, further comprising a remote User Interface (UI) provider for creating a user interface using the streaming information and providing the created user interface to the client upon the client's request.

29. The apparatus of claim 28, wherein upon receiving a streaming information request from the request transceiver, the remote UI provider sends a request for streaming information to the connection manager, receives a streaming index list from the connection manager, receives streaming information existing in the streaming index list from the database, creates a user interface on which the received streaming information is to be displayed, and provides the created user interface to the client that transmitted the request.

30. The apparatus of claim 29, wherein the user interface created using the streaming information comprises information about the content being streamed, information about the client in which the content is being streamed, and information about a play status of the content being streamed.

31. The apparatus of claim 30, wherein the information about content being streamed comprises a thumbnail image for a screen, a unique number and name of a service or channel, a broadcast time, a broadcast name, and a current play time, if the streaming is streaming of live content, and comprises a thumbnail image, a total playing time, a current play time, a file name, and a file type, if the streaming is streaming of stored content.

32. The apparatus of claim 30, wherein the information about a client in which the content is being streamed, comprises information about a device type, a device name, a device location and a device user of the client.

33. The apparatus of claim 28, wherein the user interface comprises means for selecting a request for providing content currently being streamed by the client to another client selected by a user.

34. The apparatus of claim 28, wherein the user interface comprises means for selecting a request for providing a message input by a user to another client selected by the user.

35. The apparatus of claim 28, wherein the user interface comprises means for selecting a request for providing an image file selected by a user to another client selected by the user.
